(19) United States
(12) Patent Application Publication
(10) Pub. No.: US 2015/0130383 A1
(43) Pub. Date: May 14, 2015

(54) METHOD FOR DISCHARGING ENERGY STORED IN A STATOR OF AN ELECTRIC MOTOR

(71) Applicant: VALEO SYSTEMES DE CONTROLE MOTEUR, CERGY PONTOISE CEDEX (FR)

(72) Inventors: Michel Plaideau, Presles (FR); Ludovic Raynal, La Garenne Colombes (FR); Mathieu Bertrand, Cergy Le Haut (FR)

(21) Appl. No.: 14/541,386

(22) Filed: Nov. 14, 2014

(30) Foreign Application Priority Data
Nov. 14, 2013 (FR) 1361098

(51) Int. Cl. H02P 6/00; B62D 5/04

(52) U.S. Cl. CPC H02P 6/002; B62D 5/046
USPC 318/400.22

(57) ABSTRACT

A method for discharging energy stored in a stator of an assisted steering electric motor of a motor vehicle is disclosed. The stator includes at least one electrical phase, where a state of disconnection of said phase with a control device of the stator is controlled by a switch device having at least one field effect transistor. The method involves keeping the field effect transistor in linear mode by controlling the voltage Vgs between the gate and the source of said transistor so as to keep the voltage Vds between the drain and the source of said transistor substantially equal to a reference voltage Vref.

The invention relates to a method for discharging energy stored in a stator of an electric motor, notably of an assisted steering electric motor of a motor vehicle, and to a device for discharging energy stored in a stator of an electric motor.

Motor vehicles are increasingly being equipped with an electric assisted steering device. The electric assisted steering devices use a polyphase electric motor to assist the driver in orienting the wheels of the vehicle.

For safety reasons, it is important to be able to disconnect the phases of the electric motor from the control device of the motor in the event of malfunctioning of the assisted steering device. This is because, without this, there is a risk of locking the wheels of the vehicle in the case of a malfunction. It is known practice to use phase opening electric relays in order to allow for the opening of the phases of the electric assisted steering electric motor in the case of a malfunction.

This disconnection of the phases of the motor can occur with a current in the phases of the motor that is relatively high, possibly ranging up to 160 A. Through the inductive nature of the phases of the motor, the energy stored in said phases is proportional to the square of the intensity of the current.

During the disconnection of the phases of the motor, the element generating this disconnection discharges the energy stored in the phases of the electric motor. Thus, the switch devices that make it possible to control the open state of the phases must be dimensioned to make it possible to dissipate in calorific form the energy potentially stored in the phases of the motor. Such dimensioning poses a problem of bulk in the electric motor or the motor control electronics depending on whether the switches are included in the motor or in the control electrics.

One solution to this dimensioning problem consists in disconnecting the phases of the motor only when the intensity of the current in said phases is lower than a predetermined threshold current Ib. The threshold current corresponds to an energy that can be dissipated by the switch devices without the risk of overheating, typically equal to 100 A.

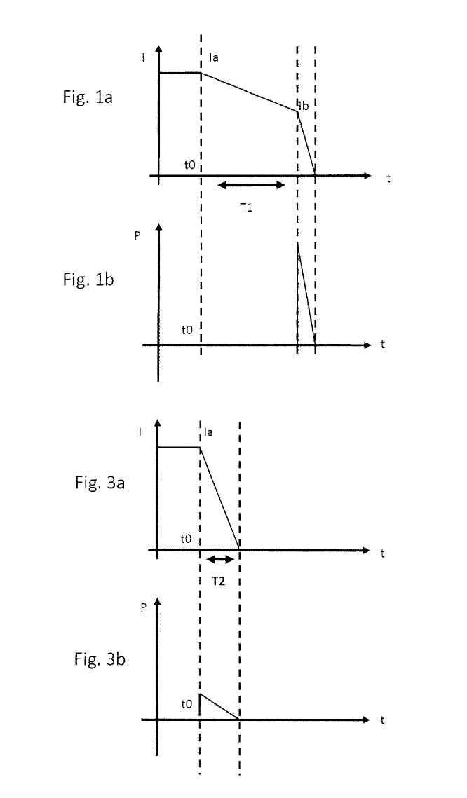

This solution is illustrated in the graphs represented in FIGS. 1a and 1b.

FIG. 1a represents the trend of the current in the phases as a function of time. FIG. 1b represents the power dissipated by the switch devices as a function of time.

As illustrated in FIG. 1a, when, at the time t0, a switch opening signal is received, the current circulating in the phases of the motor decreases from its initial value Ia to the predetermined threshold value Ib. When the current circulating in the phases of the motor reaches the threshold value Ib, the switch devices are opened. As illustrated in FIG. 1b, upon the opening of the switch device, the energy remaining in the phases of the motor is then dissipated at once.

This type of solution necessitates having a device for supervising the current circulating in the phases of the motor. This device leads to an additional cost and can be subject to failures. In particular, upon the dissipation of the energy, the temperature of the switch device increases strongly, potentially leading to the deterioration of said devices.

Thus, there is a need for a solution that makes it possible to reduce the bulk and increase the reliability of the opening of the switch devices that makes it possible to disconnect the phases of the electric assisted steering electric motor, which is also economical.

The aim of the invention, among others, is to address this need, and it is achieved by means of a method for discharging energy stored in a stator of an electric motor, notably of an assisted steering electric motor of a motor vehicle, said having at least one electrical phase, a state of disconnection of said phase with a control device of the stator being controlled by a switch device comprising at least one field effect transistor,

the method comprising a step of:
a) keeping the field effect transistor in linear mode by controlling the voltage Vgs between the gate and the source of said transistor so as to keep the voltage Vds between the drain and the source of said transistor substantially equal to a reference voltage Vref.

In particular, keeping the field effect transistor in linear mode comprises controlling the voltage Vgs between the gate and the source of said field effect transistor as a function of the difference between the reference voltage Vref and the voltage Vds between the drain and the source of said field effect transistor. Advantageously, the method according to the invention makes it possible to keep the field effect transistor in linear mode, thus preventing the transistor from switching to avalanche mode.

The energy stored in the stator of the electric motor is dissipated more slowly than when the transistor switches to avalanche mode, thus allowing for a gentler discharging of the energy. With the energy being dissipated in calorific form, the method according to the invention makes it possible to limit the temperature rise of the field effect transistor. Thus, the discharging of the energy stored in the motor according to the method of the invention allows for the use of transistors of smaller surface areas, thus reducing the bulk of the switch devices used.

Furthermore, the method according to the invention does not require any measurement of the current in the phases of the motor unlike the method according to the prior art.

Furthermore, the method according to the invention can be implemented by a standalone device, i.e. one independent of the vehicle power supplies and of the control systems, allowing for the dissipation of energy while making it totally independent of a control circuit external to said device.

The method according to the invention can also comprise one or more of the features below, considered individually or in all technically possible combinations:

the field effect transistor is of MOSFET type;

the electric motor is a polyphase motor, notably a three-phase motor, the state of disconnection of the phases being controlled by respective switch devices; and/or

the reference voltage Vref is lower than the avalanche voltage of the field effect transistor; and/or

the field effect transistor is kept in linear mode until the energy stored in the stator is discharged; and/or

the method comprising, prior to the step a) of keeping the field effect transistor in linear mode, a step a0) of reception of a phase opening signal initiating the energy discharging method; and/or

the keeping step a) immediately succeeds the step a0) of reception of a phase opening signal.

The invention also relates to a device for discharging energy stored in a stator of an electric motor, notably of an assisted steering electric motor of a motor vehicle, said stator having at least one electrical phase,

the discharging device comprising:

a switch device intended to control a state of disconnection of the phase with a control device of the stator, said switch device comprising at least one field effect transistor,

a control circuit configured to keep the field effect transistor in linear mode by controlling the voltage Vgs between the gate and the source of said transistor so as to keep the voltage Vds between the drain and the source of said transistor substantially equal to a reference voltage Vref.

In particular, the control circuit is configured to control the voltage Vgs between the gate and the source of said field effect transistor as a function of the difference between the reference voltage Vref and the voltage Vds between the drain and the source of said field effect transistor.

The device according to the invention can also comprise one or more of the features below, considered individually or in all technically possible combinations:

the device comprises a standalone electrical power supply powering at least the control circuit;

the control circuit comprises a voltage regulator of which:
the reference terminal is linked to the drain of said field effect transistor,
the anode is linked to the source of said field effect transistor, and
the cathode is linked to the gate of the field effect transistor; and/or

the cathode of the voltage regulator is linked to the gate of the field effect transistor via a bipolar transistor, the base of said bipolar transistor being linked to the cathode of the voltage regulator, and the collector of said bipolar transistor being linked to the gate of said field effect transistor; in particular, the emitter of said bipolar transistor is linked to the standalone electrical power supply; and/or

the voltage regulator is of TL431 type; and/or

the device comprises a member for receiving a phase opening signal.

The invention will be better understood from the following description given as a nonlimiting exemplary implementation thereof, and on studying the attached drawing in which:

FIGS. 1a and 1b illustrate the discharging of the energy stored in the stator of an electric motor according to a prior art method,

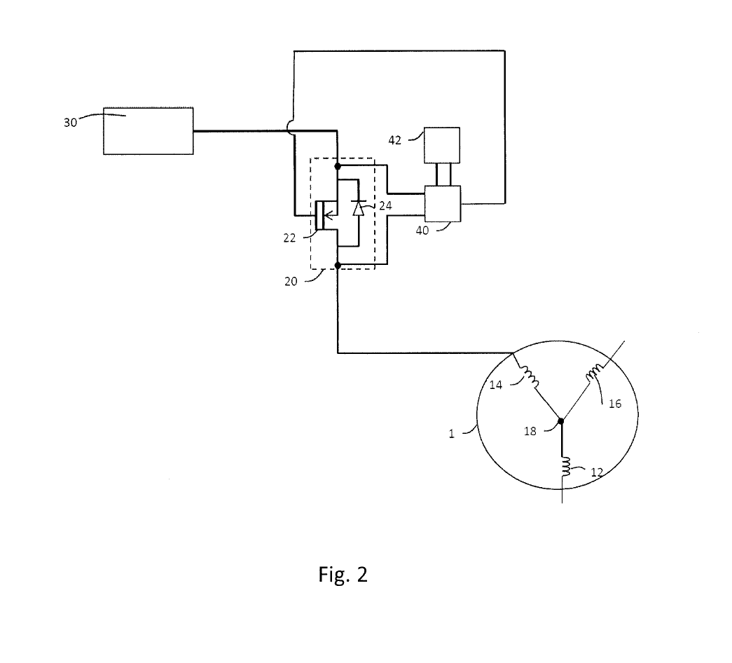

FIG. 2 represents a first configuration of an electric motor and a device making it possible to implement a method according to the invention,

FIGS. 3a and 3b illustrate the discharging of the energy stored in the stator of an electric motor according to a method according to the invention,

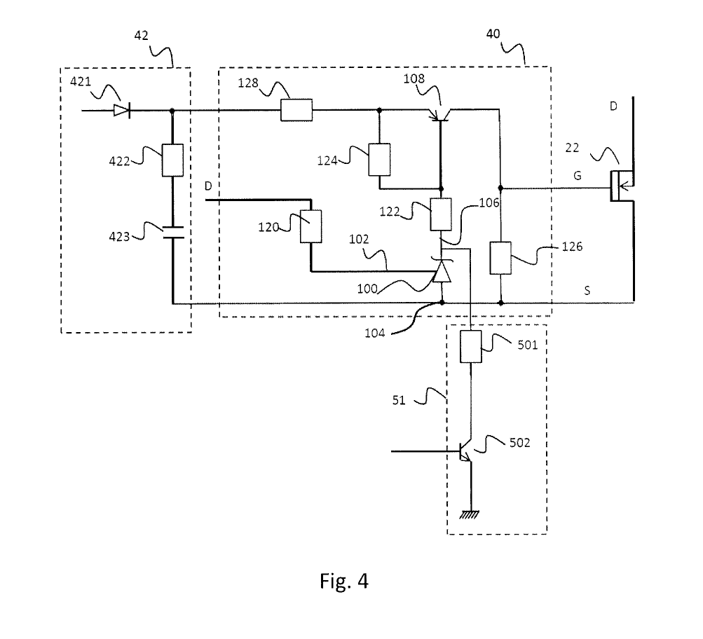

FIG. 4 illustrates an energy discharging device according to one embodiment of the invention,

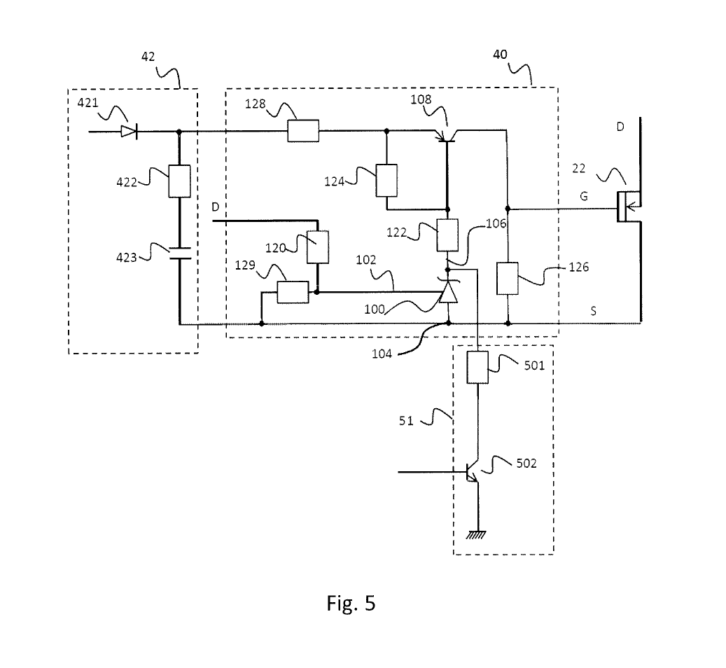

FIG. 5 illustrates an energy discharging device according to another embodiment of the invention,

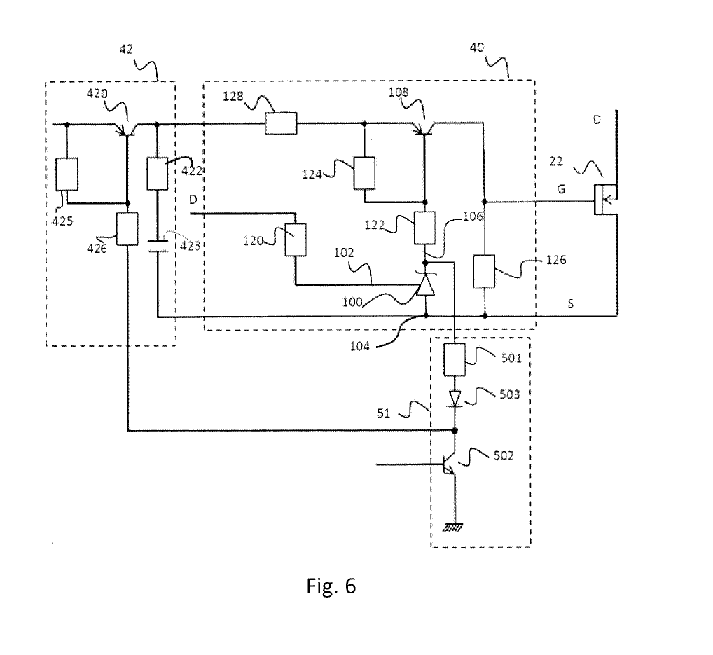

FIG. 6 illustrates an energy discharging device according to yet another embodiment of the invention, and

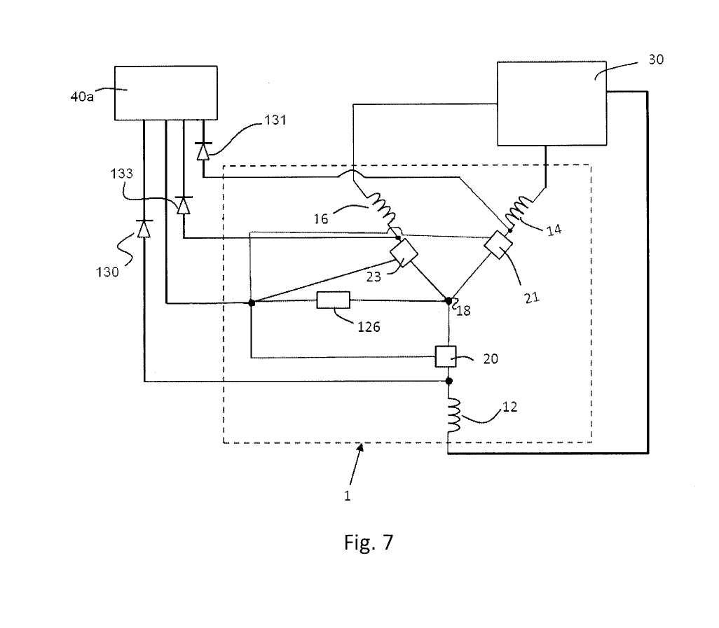

FIG. 7 represents a configuration of an electric motor and a device making it possible to implement the method according to the invention.

According to a first embodiment, the method of the invention makes it possible to discharge energy stored in the stator of an electric motor, notably of an assisted steering electric motor of a motor vehicle.

As represented in FIG. 2, an assisted steering electric motor can be polyphase, notably three-phase, and comprise a stator. 1. In the example of FIG. 2, the stator 1 comprises three electrical phases 12, 14, 16, connected in star configuration. The phases are in particular defined by an electrical winding, for example by means of electrical coils. The three electrical phases 12, 14, 16 are linked to a common neutral 18.

A switch device 20 makes the electrical connection between a phase 14 of the stator 1 and a control device 30. The switch device 20 has one terminal linked to the control device 30 and another linked to the phase 14. The control device 30 can comprise, among other things, an energy conversion device such as an invertor, and a control unit for this conversion device. The control device 30 makes it possible to power the motor, in particular the stator 1, from an energy source (not represented) such as a battery.

The state of disconnection of each of the electrical phases 12, 14, 16 with the control device 30 is controlled by a respective switch device 20. For reasons of clarity, just one switch device 20 is represented in FIG. 2.

The switch device controls the passage of a current between two terminals by virtue of a third terminal, called “control terminal”. In particular, the switch device 20 comprises a field effect transistor, notably of MOSFET type 22, with a diode 24 between the drain and the source of the transistor. The diode 24 is in practice intrinsic to the field effect transistor 22. The gate of the transistor 22 corresponds to the control electrode of the switch device 20. The anode of the diode 24 is connected to a terminal of the phase 14, in particular the terminal which is different from that linked to the neutral 18; and to a terminal of the transistor 22, in particular the source of the field effect transistor 22.

The state of opening of the switch device 20 is controlled by a control circuit 40. The control circuit 40 is powered by a standalone electrical power supply 42. In the embodiment illustrated in FIG. 2, each switch device 20 is preferably controlled by a respective control circuit 40 and standalone electrical power supply 42.

The control circuit 40, with, in particular, the standalone electrical power supply 42, makes it possible to implement the energy discharging method according to the invention, which comprises the keeping of the transistor 22 in linear mode.

As explained previously, for reasons of safety, in the case of a motor control fault, it is preferable to disconnect the phases 12, 14, 16 from the control device 30 in order to leave the rotor of the motor free to rotate. The opening of the switch devices 20, 21, 23 may entail discharging a relatively significant quantity of energy as a function of the intensity of the current present in the phases 12, 14, 16 before the disconnection.

The method according to the invention makes it possible to discharge the energy stored in the phases of the stator by keeping the transistor 22 in linear mode. The method for discharging energy stored in the stator therefore comprises a step of keeping the field effect transistor 22 in linear mode.

The method according to the invention is illustrated in the graphs represented in FIGS. 3a and 3b.

FIG. 3a represents the trend of the current in a phase 12, 14, 16 as a function of time. FIG. 3b represents the power dissipated by a switch device 20, 21, 23 as a function of time.

Upon the detection of a failure, an assisted steering control or operation fault for example, the energy discharging device receives a phase disconnection signal. The phase disconnection signal can, for example, originate from the control unit of the control device 30. The transmission of this disconnection signal can be accompanied by an interruption of the energy supply to the motor.

In the prior art, in the absence of the control circuit 40, the switch device 20 is open. The voltage between the drain and the source of the transistor 22 then rises to reach the avalanche voltage of the transistor. The expression “avalanche voltage” means that the transistor has an avalanche property. In other words, when the voltage between the two terminals of the transistor—in particular between the drain and the source—becomes greater than or equal to a threshold voltage, called “avalanche voltage”, the transistor can allow a strong current to pass between its two terminals, which can result in its destruction, and do so even though its control terminal has not received a switch closure signal.

According to the method of the invention, the field effect transistor 22 is kept in linear mode by virtue of the control circuit 40 which controls the voltage Vgs between the gate and the source of the transistor 22 so as to keep the voltage Vds between the drain and the source of said transistor 22 substantially equal to a reference voltage Vref. Since the reference voltage Vref is lower than the avalanche voltage of the field effect transistor 22, keeping the voltage Vds below the reference voltage makes it possible to avoid having the transistor switched to avalanche mode.

Typically, for a field effect transistor for which the nominal operating drain-source voltage is of the order of 30V, the avalanche voltage is of the order of 40V and, for a field effect transistor for which the nominal operating drain-source voltage is of the order of 40V, the avalanche voltage is of the order of 50V.

According to one embodiment, the reference voltage is of the order of 2.5 Volts.

Preferably, the transistor 22 is kept in linear mode until the energy stored in the stator is discharged. Typically, the transistor 22 is kept in linear mode for a time T2 determined by the reference voltage. The higher the reference voltage, the shorter the time T2 in linear mode. Typically, the time T2 is of the order of a few ms, for example greater than or equal to 3 ms and/or less than or equal to 100 ms.

Advantageously, the discharging of the energy stored in the stator of the motor is slower when the transistor 22 is kept in linear mode than when the transistor switches to avalanche mode. Typically, the energy is discharged in approximately 100 μs when the transistor switches to avalanche mode whereas it is discharged in several milliseconds when the transistor is kept in linear mode.

As an example, the inventors have observed that the discharging of an energy of 1 Joule in 200 μs leads to a rise in temperature of the transistor that can range up to 250° C. whereas the discharging of the same energy in 4 ms makes it possible to keep the temperature of the transistor below 50° C. Thus, slowing down the discharging of the energy stored in the stator 1 upon the disconnection of the phases 12, 14, 16 compared to the prior art makes it possible to protect the switch device 20 from an excessive rise in its temperature.

In the example illustrated in FIG. 2, the switch device 20 is situated between the phase 14 and the control device 30. One terminal of the switch device 20 is connected to a terminal of the phase 14; the other terminal of the switch device 20 is connected to the control device 30. Alternatively, the switch device 20 can be situated between the phase 14 and the neutral 18. One terminal of the switch device 20 is then connected to a terminal of the phase 14, the other terminal being connected to the neutral 18.

According to one embodiment of the invention represented in FIG. 4, the control circuit 40 comprises a voltage regulator 100. The voltage regulator 100 acts on the voltage between its cathode and its anode in order to keep the voltage between its reference terminal and the anode at a predetermined voltage. Preferably, this predetermined voltage corresponds to the reference voltage Vref described previously. The predetermined voltage of the voltage regulator 100 is an intrinsic datum of the regulator, and is, for example, substantially equal to 2.5 Volts. The voltage regulator 100 can be a voltage regulator U16 of TL431 type.

Advantageously, the voltage regulator 100 ensures the voltage mode servocontrolling of the field effect transistor 22, thus keeping it in linear mode.

As represented in FIG. 4, the reference terminal 102 of the voltage regulator 100 is linked to the drain of the field effect transistor 22 via a resistor 120. The resistor 120 typically has a value of between 1 KΩ and 10 KΩ.

The anode 104 of the voltage regulator 100 is linked to the source of the field effect transistor 22.

The cathode 106 of the voltage regulator 100 is linked to the gate of the field effect transistor 22 via a transistor 108. This transistor 108 notably becomes conductive when the difference between its base potential and its emitter potential is below a threshold, for example 0.6V. The transistor 108 is, for example, a bipolar transistor, notably of PNP type.

In particular, the cathode 106 of the voltage regulator 100 is linked to the base of the bipolar transistor 108 via a resistor 122. The resistor 122 for example has a value of between 1 KΩ and 10 KΩ.

A resistor 124 can be mounted between the base of the bipolar transistor 108 and the emitter of said bipolar transistor 108 in order to bias the bipolar transistor 108. The resistor 124 can have a value of between 500Ω and 1500Ω, for example substantially equal to 1 kΩ.

The collector of the bipolar transistor 108 is linked to the gate of the field effect transistor 22.

A resistor 126 notably of between 40 kΩ and 60 kΩ, for example of approximately 47 kΩ, is mounted between the source and the gate of the field effect transistor 22 to bias the field effect transistor 22.

The emitter of the bipolar transistor 108 is linked to the electrical power supply 42 via a resistor 128 with a value notably of between 50Ω and 150Ω, for example around 100Ω.

The electrical power supply comprises a power supply circuit 42 also represented in FIG. 4. The circuit 42 is, for example, arranged between the resistor 128 and the anode 104 of the voltage regulator 100. According to the example represented in FIG. 4, the power supply circuit 42 comprises a diode 421 linked on the one hand to a power source (not represented), for example the battery of the vehicle, and, on the other hand, to the resistor 128 and to a second resistor 422 mounted in series with a capacitor 423.

Typically, the resistor 422 is between 1Ω and 100Ω and the capacitor 423 is between 100 nF and 10 μF.

The capacitor 423 is, for example, also linked to the anode 104 of the voltage regulator 100. In normal operation, the voltage at the input of the power supply circuit 42 is, for example, of the order of 12 Volts. This voltage originates, for example, from a low-voltage battery of the vehicle. The capacitor 423 is kept charged by this voltage.

Upon the disconnection of the motor phases, the voltage at the input of the power supply circuit 42 changes to 0 or approximately 0 volt, for example because the electrical power supply from the low-voltage battery is interrupted. The capacitor 423 then independently powers the energy discharging device, in particular the control circuit 40 and the switch device 20. The capacitor 423 is advantageously dimensioned in order to make it possible to power the control circuit 40 for a sufficient time to discharge the energy stored in the stator 1 upon the disconnection of the phases 12, 14, 16. In particular, the capacitor 423 powers the control circuit 40 for a time which corresponds to the time T2 during which the transistor 22 is kept in linear mode. For example, the capacitor 423 powers the control circuit 40 for approximately 5 ms after the voltage at the input of the power supply circuit 42 changes to 0 Volt or substantially 0 Volt.

When the capacitor 423 is discharged, the control circuit 40 is no longer powered; the field effect transistor 22 becomes open because it is no longer receiving voltage on its gate. However, the field effect transistor 22 does not enter into avalanche mode because the energy stored in the stator 1 has been discharged.

The device can also comprise a control unit 51 also represented in FIG. 4. According to the example represented in FIG. 4, the control unit 51 is linked to the anode 104 of the voltage regulator 100. The control unit 51 can comprise a resistor 501 between the anode 104 of the voltage regulator 100 and the collector of a transistor 502. This transistor 502 notably starts to conduct when the difference between its base potential and its emitter potential is above a threshold, for example 0.6V. The transistor 502 is, for example, a bipolar transistor, notably of NPN type. The emitter of the bipolar transistor 502 is linked to the ground and the base of said transistor is connected to a control member, for example the control device 30 of the stator. The state of the bipolar transistor 502 is then controlled by the control device 30.

In normal operation, the bipolar transistor 502 conducts. The voltage regulator 100 is then disabled; and the bipolar transistor 108 conducts. Upon the disconnection of the phases of the motor, the bipolar transistor 502 is open. The voltage regulator 100 is then active; the state of the bipolar transistor 108 is controlled by the voltage delivered by the voltage regulator 100.

According to an embodiment represented in FIG. 5, a resistor 129 is added between the anode 104 and the reference terminal 102 of the voltage regulator 100 in order to adjust the value of the reference voltage Vref of the voltage regulator 100. Advantageously, the resistor 129 added between the anode 104 and the reference terminal 102 is adjustable so as to be able to adjust the reference voltage Vref of the voltage regulator.

According to an embodiment illustrated in FIG. 6, the power supply circuit 42 can comprise a switch, in particular a transistor 420, in place of the diode 421. This transistor 420 notably starts to conduct when the difference between its base potential and its emitter potential is below a threshold, for example 0.6V. The transistor is, for example, a bipolar transistor 420, notably of PNP type. The collector of the bipolar transistor 420 is notably linked on the one hand to a terminal of the resistor 422 mounted in series with the capacitor 423, and on the other hand with the terminal of the resistor 128 which is opposite to that linked to the transistor 108 of the control circuit 40. The emitter of the bipolar transistor 420 is connected to the input of the power supply circuit 42. The base of the bipolar transistor 420 is linked to the collector of the transistor 502 of the control unit 51 via a resistor 426. By virtue of the resistors 425, 426 and of the transistor 502, the state of the transistor 420 can be controlled. In normal operation the transistor 420 conducts in order to charge the capacitor 423 and keep the switch device 20 conducting. Upon the disconnection of the motor phases 12, 14, 16, the transistor 420 of the power supply circuit 42 is open. Thus, whatever the voltage delivered at the input of the power supply circuit 42, there is an assurance that the disconnection will be made independently by virtue of the capacitor 423. To facilitate the control of the transistor 420 of the power supply circuit 42, the control unit 51 can comprise a diode 503 mounted in series between the resistor 501 and the transistor 502. The cathode of the diode 503 is linked to the collector of the transistor 502; the anode of the diode 503 is linked to a terminal of the resistor 501.

FIG. 7 illustrates another embodiment of the device according to the invention. The stator 1 comprises three electrical phases 12, 14, 16, connected in star configuration. The phases are in particular defined by an electrical winding, for example by means of electrical coils. A switch device 20, 21, 23 is arranged between each of the three electrical phases 12, 14, 16 and the neutral of the phases.

In this embodiment, a single control circuit 40 and/or a single standalone electrical power supply 42 are used to control the switch devices 20, 21, 23. The control circuit 40 and the standalone power supply are preferably identical to those illustrated in FIGS. 4 to 6. For reasons of clarity, the standalone electrical power supply is not represented in FIG. 7; the impedance 126 of the control circuit 40 is represented; the other components of the control circuit 40 are represented in a block 40a. A single impedance 126 is arranged between the terminal of the switch device 20, 21, 23 which is not linked to the phase 12, 14, 16—this terminal is here linked to the neutral 18—and the control electrode of each of the switch devices 20, 21, 23. One and the same impedance 126 is therefore common to all three switch devices 20, 21, 23.

Advantageously, this configuration makes it possible to limit the number of components and of wires between the control circuit 40 and the switch devices 20, 21, 23. In effect, a single wire is needed to control the open state of the switch devices 20, 21, 23. A single control circuit 40 makes it possible to control the opening and closure states of all the switch devices 20, 21, 23.

In a variant, for each switch device 20, 21, 23, a respective diode 130, 131, 133 is connected between a terminal of the switch device 20, 21, 23 and the resistor 120 linked to the reference terminal 102 of the voltage regulator 100. In particular, the diode 130, 131, 133 has its anode connected to a terminal of the switch device, notably to the drain of the transistor 22; and the diode has its cathode connected to the terminal of the resistor 120 which is different from that connected to the reference terminal 102 of the voltage regulator 100.

In the example illustrated in FIG. 7, the switch devices 20, 21, 23 are situated between their respective phase 12, 14, 16 and the neutral 18. One terminal of the switch device 20, 21, 23 is connected to a terminal of the phase 12, 14, 16, the other terminal being connected to the neutral 18. Alternatively, the switch devices 20, 21, 23 can be situated between the phase 12, 14, 16 and the control device 30. One terminal of the switch device 20, 21, 23 is then connected to a terminal of the phase 12, 14, 16; the other terminal of the switch device 20, 21, 23 is connected to the control device 30.

The method according to the invention can be applied to star phase configurations as represented in FIGS. 2 and 7 and to delta phase configurations.

More generally, the invention is not limited to the examples described. It is obvious that numerous adaptations to the configurations described above can be introduced while retaining at least some of the advantages of the invention. Notably, the embodiment illustrated in FIG. 6 can comprise a resistor 129 added between the anode 104 and the reference terminal 102 of the voltage regulator 100, as illustrated in FIG. 5.

The expression “comprising a” should be understood to be synonymous with the expression “comprising at least one”, unless specified otherwise.

1. A method for discharging energy stored in a stator of an assisted steering electric motor of a motor vehicle, said stator having at least one electrical phase, a state of disconnection of said phase with a control device of the stator being controlled by a switch device comprising at least one field effect transistor, the method comprising a step of:
a) keeping the field effect transistor in linear mode by controlling the voltage Vgs between a gate and a source of said transistor so as to keep the voltage Vds between a drain and the source of said transistor substantially equal to a reference voltage Vref.

2. The method for discharging energy as claimed in claim 1, wherein the electric motor is a three-phase motor, the state of disconnection of the phases being controlled by respective switch devices.

3. The method for discharging energy as claimed in claim 1, wherein the reference voltage Vref is lower than an avalanche voltage of the field effect transistor.

4. The method for discharging energy as claimed in claim 1, wherein the field effect transistor is kept in linear mode until the energy stored in the stator is discharged.

5. The method for discharging energy as claimed in claim 1, further comprising, prior to the step a) of keeping the field effect transistor in linear mode, a step a0) of reception of a phase disconnection signal initiating the energy discharging method.

6. The method for discharging energy as claimed in claim 5, wherein the keeping step a) immediately succeeds the step a0) of reception of a phase opening signal.

7. A device for discharging energy stored in a stator of an assisted steering electric motor of a motor vehicle, said stator comprising at least one electrical phase,
the discharging device comprising:
a switch device intended to control a state of disconnection of said phase with a control device of the stator, said switch device comprising at least one field effect transistor, and
a control circuit configured to keep the field effect transistor in linear mode by controlling the voltage Vgs between a gate and a source of said transistor so as to keep the voltage Vds between a drain and the source of said transistor substantially equal to a reference voltage Vref.

8. The energy discharging device as claimed in claim 7, further comprising a standalone electrical power supply powering at least the control circuit.

9. The energy discharging device as claimed in claim 7, wherein the control circuit comprises a voltage regulator of which:
the reference terminal is linked to the drain of said field effect transistor,
the anode is linked to the source of said field effect transistor, and
the cathode is linked to the gate of the field effect transistor.

10. The energy discharging device as claimed in claim 9, wherein the cathode of the voltage regulator is linked to the gate of the field effect transistor via a bipolar transistor, the base of said bipolar transistor being linked to the cathode of the voltage regulator, and the collector of said bipolar transistor being linked to the gate of said field effect transistor.

11. The energy discharging device as claimed in claim 7, wherein the voltage regulator is of TL431 type.

12. The energy discharging device as claimed in claim 7, further comprising a member for receiving a phase opening signal.
